(19) United States
(12) Patent Application Publication
(10) Pub. No.: US 2006/0012564 A1
(43) Pub. Date: Jan. 19, 2006

(54) Hard disk multimedia player and method

(75) Inventors: Masazumi Shiozawa, Tokyo (JP); Hiroyuki Kondo, Tokyo (JP); Masahiko Hajiri, Kanagawa (JP); Kenji Miyasaka, Kanagawa (JP); Takamasa Ito, Tokyo (JP); Shoichiro Matsuoka, Kanagawa (JP); Taku Sugawara, Tokyo (JP); Satoshi Akagawa, Tokyo (JP); Hidehiko Yamamoto, Kanagawa (JP); Osamu Udagawa, Kanagawa (JP); Naoki Mato, Kanagawa (JP); Koichi Sayama, Ibaraki (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 11/166,208

(22) Filed: Jun. 27, 2005

Related U.S. Application Data
(60) Provisional application No. 60/587,026, filed on Jul. 13, 2004.

(51) Int. Cl. G09G 5/00

(52) U.S. Cl. 345/156

(57) ABSTRACT

A hand-held display apparatus including a body which is gripped by a user's hand, and an interface to output image data. A display is also provided which displays an image received from the interface and vertically inverts the image in response to a vertical inversion signal. The device also includes a plurality of sensors, which are to be manipulated by a user's hand, and are disposed in proximity to the display symmetrically around a horizontal axis in relation to the display section. A processor is also provided which outputs the vertical inversion signal and reverses the functionality of at least one of the plurality of sensors.

### CROSS REFERENCE TO RELATED PATENT DOCUMENTS

This application claims the benefit of the earlier filing date of U.S. patent application Ser. No. 60/587,026 filed on Jul. 13, 2004, the entire contents of which is incorporated herein by reference.

### BACKGROUND OF THE INVENTION

1. Field of the Invention

This invention relates to a system, apparatus, method, and computer program product relating to storage and playing of multimedia data.

2. Discussion of the Background

With the proliferation of mobile music and general multimedia playing devices there has been a need to develop an improved portable unit on which multimedia images, videos and music can be played. Digital multimedia files are now widely available allowing music, video or images to be easily transported and reproduced in a variety of mobile devices.

However, current multimedia devices are typically suited to operate only on a single type of multimedia file. For example, digital music players are available which allow a user to transport and reproduce digital music files. A user may download digital music data from an external processor, such as a personal computer, to be stored and subsequently reproduced by the device. These devices, however, tend to be small in size and have enough memory hold audio files so as to emphasize a small size of the device, thus constraining the amount of music that may be stored on the device. Further, these small music-only devices typically have a small monochrome display not suitable for displaying a comprehensive graphical user interface (GUI). The small display also prohibits the display of digital video files which may be reproduced and viewed by a user. Consequently, many of these devices are not configured to reproduce files having a digital video format which require a visual display. Generally, these devices sacrifice a display sufficient for viewing an audio file, and have a size reduced amount of memory in order to be increasingly small in size and mobile in nature.

Mobile video reproduction devices are also commercially available which allow a user to download digital video files from an external processing device, or from a removable storage medium, such as a Digital Versatile Disc (DVD) and reproduce these files on via a display apparatus. These devices are larger in size so as to facilitate the display of a video file and the ability to house a DVD, or other substantial for of memory. However, because these devices are large in size, the mobility of the device is substantially constrained. Further, these devices are typically suited to display video image data in a particular format (for example, from a DVD), and are not configured to reproduce other types of digital media such as still pictures and music. The large size of the device also prevents the device from being held and operated by a user in one hand.

### SUMMARY OF THE INVENTION

The present invention addresses and resolves the above identified, as well as other limitations, with conventional portable multimedia players. These devices also suffer because of poor design, and lack of portability. Specifically, these devices include buttons that can inadvertently be pressed when the device is placed in a user's pocket. Further, because of the size of the screen on devices which display images, these devices are typically, bulky and have a poor ergonomic design for the user of the device. Also, the graphical user interface of these devices does not allow for a convenient and easy operation of the device.

The present invention provides a device that is configured to be held by a user with one hand allowing for easy navigation through the menus on the portable device. A display is located on the front of the device which displays menus, images, and videos as selected by the user, by using the user interface. The multimedia player includes sufficient storage capacity to allow the user of the device to store a number of video, image and/or music files.

There are also various outputs on the device which permit the device to be connected to a television which can then display the image as presented on the display. An interface is also available which permits the user to download digital files to the multimedia player from other devices. A headphone jack is also provided, which permits the user to listen to audio data associated with the music of video file being played by the user of the device.

The multimedia player includes sensors in the form of concave buttons, which prevent the buttons from being actuated when the device is placed, for example, in a user's pocket. The sensors have a concave surface disposed in proximity to the display section and extend along a vertical direction of movement of a cursor displayed on the display section. The buttons are configured so that they can be activated by a user's finger while holding the device in either a left hand or a right hand. The processor in the device reacts to the actuation of the buttons by changing the location of a cursor or other portion of the user interface on the screen.

Since the multimedia device is configured to be operated by the user by only using one hand, the device has an inversion function. This inversion function allows a user who is left handed to invert the display and the functionality of the vertical slide bar in order to more easily operate the device with the left hand. When the device is set to inversion mode, a vertical inversion signal is created by an inversion circuit and results in the image displayed on the device being inverted. Further, the operation of the vertical sensors can be inverted around its horizontal axis in response to the vertical inversion signal.

The housing of the device, including a unique battery enclosure serves as a gripping portion for the user's hand. Specifically, the battery enclosure is cylindrical in shape, which allows the users hand (either right or left) to cradle the battery enclosure when gripping the multimedia player. The battery enclosure and control section are integrated into a single housing, and the battery enclosure is used as a gripping portion for the user to grip with the user's hand so that the user may operate the control section with the user's thumb.

Another aspect of the multimedia player is the hierarchical menu structure, which allows user's to search for various files in specified categories and select specific files that are to be played. A cursor is configured to move vertically and horizontally on the display to allow the user to make selections from a plurality of menu options. A control section disposed in the proximity to the display section generates a signal based on user inputs and moves the cursor in at least a vertical and horizontal direction. An upper hierarchy menu can be selected by the operation of the control section in one direction, and a lower hierarchy menu can be selected by operation of the control section in another direction. Therefore, the user is easily able to search main categories and sub-categories within the menu hierarchy with ease.

Another aspect of the multimedia display device is the operation of the vertical button which allows for a single directional user input (up or down) and also allows for a continuous sliding motion, at various speeds, to take place. The motion of the cursor is dictated by the actuation of a user's finger along the vertical slide bar, and the user is able to set the cursor in motion by making contact with the bar and sliding his/her finger up and down along the bar. This allows the cursor to continue to scroll up or down, and for the user to easily scan through various selections in the hierarchical menu described above. As stated above, the moving speed of the cursor changes based on the speed of vertical actuation of the sensor, and the moving speed of the cursor is maintained at the last actuated speed while the sensor continues to be actuated in a stationary position. Thus, when a user slides his/her finger along the sensor the cursor scrolls until the user removes his/her finger from the sensor.

### BRIEF DESCRIPTION OF THE DRAWINGS

A more complete appreciation of the invention and many of the attendant advantages thereof will be readily obtained as the same becomes better understood by reference to the following detailed descriptions and accompanying drawings:

FIG. 1 is a front view of a reproduction apparatus according to one embodiment of the present invention.

FIG. 2 is a plan view of the reproduction apparatus shown in FIG. 1.

FIG. 3 is a left side elevational view of the reproduction apparatus shown in FIG. 1.

FIG. 4 is a view showing a side face of the device in FIG. 3 in a state wherein a cap is open.

FIG. 5 is a block diagram showing a general configuration of the reproduction apparatus shown in FIG. 1.

FIG. 6 is a plan view of the vertical direction button.

FIG. 7 is a vertical sectional view of FIG. 6.

FIG. 8 is a sectional view taken along the line A-A of FIG. 6.

FIG. 9 is a view showing a title of the screen of the “video” displayed on a display section of the reproduction apparatus shown in FIG. 1.

FIG. 10 is a view showing a title screen of “music” displayed on the display section of the reproduction apparatus shown in FIG. 1.

FIG. 11 is a view showing a title screen of “photo” displayed on the display section of the reproduction apparatus shown in FIG. 1.

FIG. 12 is a view showing a title screen of “setup” displayed on the display section of the reproduction apparatus shown in FIG. 1.

FIG. 13 is a flowchart illustrating operation of the vertical direction button of the reproduction apparatus shown in FIG. 1.

FIG. 14 is a flowchart illustrating operation of the vertical direction button of the reproduction apparatus shown in FIG. 1.

FIG. 15 is a view showing a configuration of a display section.

FIG. 16 is a view showing an example of an ordinary screen displayed on the display section of the reproduction apparatus shown in FIG. 1.

FIG. 17 is a view showing an example of a vertically inverted screen displayed on the display section of the reproduction apparatus shown in FIG. 1.

FIG. 18 is a flowchart illustrating a vertical inversion operation.

FIG. 19 is a view showing example of a table for button inversion.

FIG. 20 is a flowchart illustrating operation of restoring a standard display from a vertically inverted display.

FIG. 21 is a view showing another example of the table for button changeover.

FIG. 22 is a view showing a further example of the table for button changeover.

FIG. 23 is a view showing still a further example of the table for button changeover.

FIG. 24 is a block diagram of a computing device which can be used to transmit files to the multimedia player.

### DETAILED DESCRIPTION OF THE INVENTION

The following comments relate to the drawings, wherein like reference numerals designate identical or corresponding parts throughout the several views.

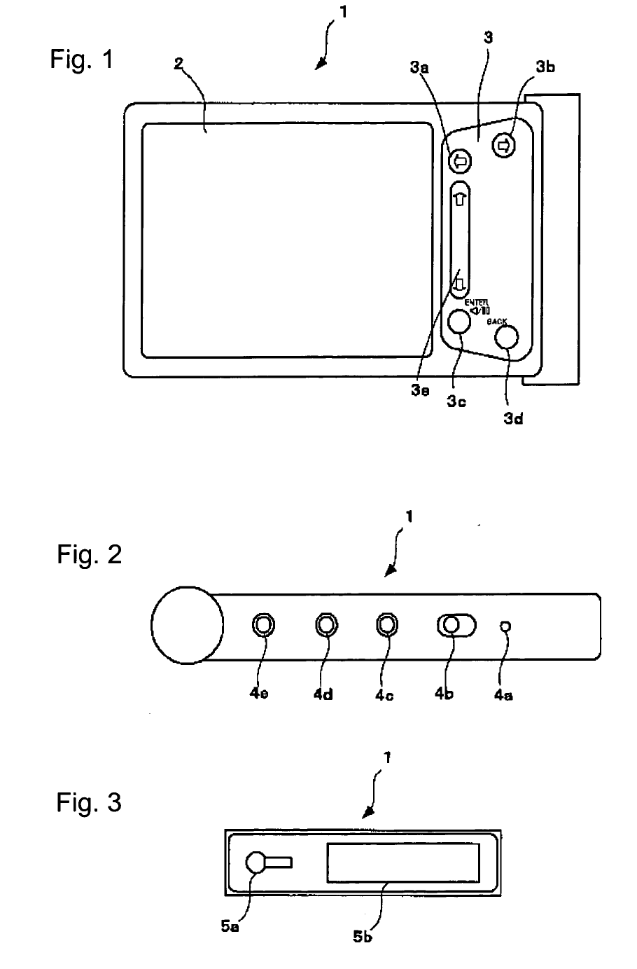

FIG. 1 is a front elevational view showing an appearance of a multimedia reproduction apparatus according to an embodiment of the present invention; FIG. 2 is a plan view of the reproduction apparatus, and FIG. 3 is a left side elevational view of the apparatus.

The multimedia reproduction apparatus 1 has a size similar to that of a hand-held type of electronic devices, such as a Personal Digital Assistant (PDA). The multimedia reproduction apparatus 1 is also configured such that the device can be held and controlled with only one hand (left or right). With one hand holding the device, the user can watch a video image, view a still picture, but even when multimedia reproduction apparatus 1 is placed in the user's pocket the user may listen to music via headphones. The reproduction apparatus 1 also functions as an externally provided hard disk apparatus when in communications with a personal computer, or any other device from which digital data may be downloaded. Thus, when the multimedia reproduction device 1 is connected to a personal computer through a USB cable (IEEE 1394 or i-Link), for example, the personal computer views the image reproduction device as an external storage medium.

Various formats of digital video, music and still image data are capable of being reproduced by the multimedia reproduction apparatus 1. Examples of video formats capable of being reproduced include, but are not limited to; Video Capsules, MPEG, AVI (DV), DVR-MS, and WMV files. Examples of still image file formats that are compatible with the system include, but are not limited to; JPEG, BMP, GIF, PNG, TIFF, and PictureGear Pocket Format. Compatible music formats include, but are not limited to; MP3 and WAV files. The above-mentioned formats are intended to be provided only as examples as the multimedia reproduction apparatus 1 is capable of handling a great deal of additional file formats. Further, the multimedia reproduction apparatus 1 is capable of being viewed as an external hard disk for a processing device, and therefore can be used to store and transport filed of any format.

As shown in FIG. 1, a display section 2 in the form of a liquid crystal display (LCD) apparatus approximately 3.5 inches in size is disposed on the front face of the reproduction apparatus 1. This display is not limited to being an LCD display, but could also be a Light Emitting Diode (LED), a plasma display or any other similarly suitable display. The display section 2 is used to display still images, video images, and the Graphical User Interface (GUI) which is operated by the user. The GUI is controlled by way of a user interface which allows the user to navigate through various menu selections and files that are stored in the multimedia reproduction apparatus 1. The user interface is in the form of an operation panel 3 which is provided on the right side of the display section as illustrated in FIG. 1, allowing the user to navigate through the GUI displayed on the display section 2. The operation panel 3 and the components thereof are described in greater detail below.

A plurality of horizontal direction buttons 3a, 3b, a BACK button 3d, an ENTER button 3c, and a vertical direction button 3e are provided on the operation panel 3. The horizontal direction buttons 3a, 3b are used to perform changeover of a tab on a title screen and perform fast-forwarding and rewind operations of the contents of a file being reproduced by the multimedia reproduction apparatus 1. The BACK button 3d is used to cancel an operation, return to a preceding screen, or to stop reproduction of a file. The ENTER button 3c is used to select an item, execute a function, or to reproduce/display a file. The vertical direction button 3e is used to actuate the cursor displayed on the display section 2 in an upward or downward direction vertically on the screen. Each of these buttons is optionally configured with a built-in touch sensor which operates only when it is touched lightly, and has a surface which is concave so that an unintended operation by an inadvertent touch can be prevented. Further, an indication mark of a “←” is indicated for button 3a, an another indication mark of “→” is indicated for button 3b, a further indication mark of “ENTER” is indicated for the “ENTER” button 3c and an indication mark of “BACK” is indicated for the “BACK” button 3d on the panel. These buttons all allow the user of the device to navigate through various options and menus that are presented to the user while operating the device. The physical operation of the capacitively coupled buttons will be described in greater detail below. While the term “button” is used, the function performed is to enter selections via a physical man-machine interface, even if the activation is not by depressing a switch.

As shown in FIG. 2, an access lamp 4a, a power supply switch 4b, a volume-decrease button 4c, a volume-increase button 4d and a “TOOLS” button 4e are provided on an upper face of the multimedia reproduction apparatus 1. The access button 4a can be lit in a variety of different fashions to indicate different operational situations of the multimedia reproduction apparatus 1. For example, when lit green, it indicates the power supply is on; when lit orange, it indicates the built-in battery is being charged; when flickering green, it indicates that the built-in hard disk is being accessed from an external computing device connected to the multimedia reproduction apparatus 1; and when the light is flickering orange, it indicates that the remaining capacity of the built-in battery is small. The power supply switch 4b is used to connect or disconnect the power supply by being depressed for more than one second to the “POWER” side. The power supply switch, however, is also used to invalidate the operation buttons by being sent to the “HOLD” side. Using the “HOLD” operation debilitates the functionality of the buttons and allows the user to manipulate the device in his/her hand, while not effecting the operation of the device by inadvertently touching one or more of the buttons, since the buttons are deactivated. The volume-decrease button 4c and the volume-increase button 4d are used to adjust the sound volume upon reproduction of an audio file, or a file with an audio component. The “TOOLS” button 4e is used to cause a display section 2 to display a menu of operations which can be executed on a currently displayed screen.

The “TOOLS” menu is available to a user regardless of the type of multimedia being reproduced. When a file is being reproduced by the multimedia reproduction apparatus 1 and the user depresses the “TOOLS” button 4e, a menu appears providing a variety of options to the user, some of these options include: change the method by which the stored files are sorted (date, name, etc.), mark specific files for deletion, adjust image quality (i.e. contrast, brightness, backlight), change audio channel (i.e. stereo, main, sub), modify image aspect ratio (for video), repeat playback (automatically replay a file upon completion), adjust sound quality (i.e. treble, bass, etc.), enable or disable the operation beep, configure the information display (i.e. automatically hide the file name after a specified interval), shuffling playback (for music, etc.), changing display mode (display still images via thumbnail along the top of the screen, or select full size, etc.), and slideshow settings (still images, i.e. interval, sort, repeat). As mentioned above, some of these options exist only for specific types of reproduced files (video, still image, music), while others are available for multiple file types.

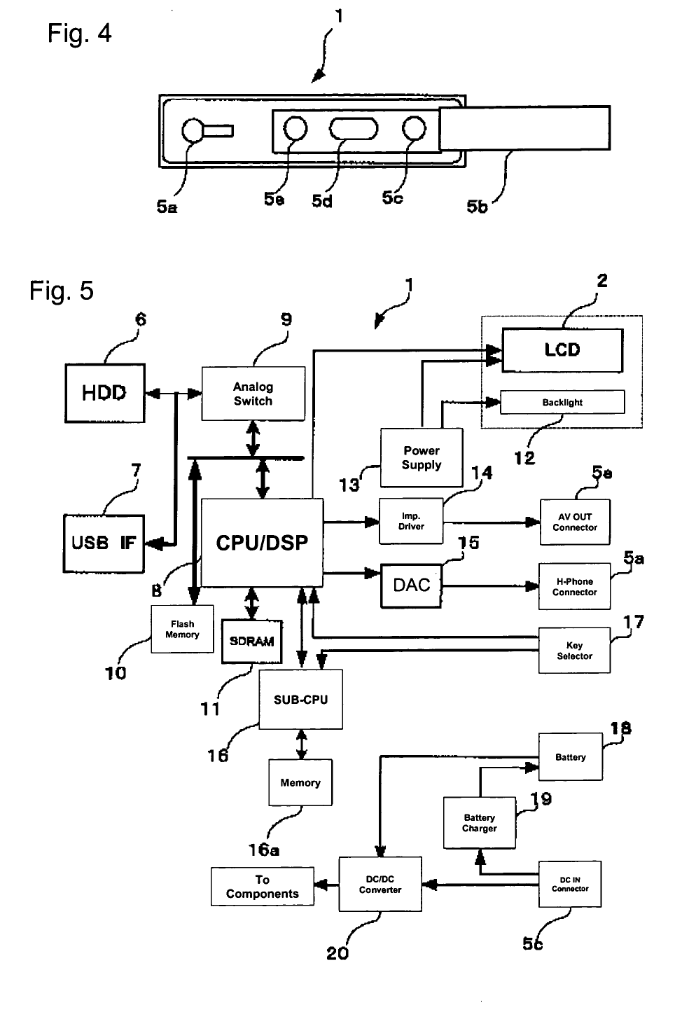

Referring to FIG. 3, a headphone connector 5a and a movable cap 5b are provided on the left side face of the multimedia reproduction apparatus 1. FIG. 4 shows the reproduction apparatus 1 and a state with cap 5b opened. At the portion exposed by the open cap 5b, “DC IN” connector 5c is provided for connecting an AC adaptor to provide power to the device. The “DC IN” connector 5c can be used to recharge the battery 18 via the battery charger 19, or supply operational power to the multimedia reproduction apparatus 1 via the DC/DC converter 20 in FIG. 5. A USB connector 5d is provided for connecting a USB cable (or other data transfer cable) between an external processing device and the multimedia reproduction apparatus 1. Also, an “AV OUT” connector 5e is provided for connecting a cable facilitating the transmission of a still image, or moving video, reproduced by the multimedia reproduction apparatus 1 to a television, or the like, to be displayed.

Also, the battery of the multimedia reproduction apparatus 1 can be charged via the “DC IN” connector 5c, or the USB connector 5d. A battery-shaped icon is displayed on the display section 2 of the device informing the user of the amount of power remaining in the battery. Various levels of the battery are depicted via the icon displayed on the display 2 of the multimedia device. An icon in the shape of an AC plug is displayed when the multimedia reproduction apparatus 1 is connected to the AC power adapter.

FIG. 5 is a block diagram showing a general configuration of the internal operations of the multimedia reproduction apparatus 1.

Referring to FIG. 5, the multimedia reproduction apparatus 1 includes a hard disk 6 having a storage capacity of approximately 20 gigabits for storing music data, video data, photo data and other necessary data. It should be noted that both the method of storage and the medium used to store the data can be varied. For example, USB flash drive, internal flash memory, CompactFlash cards, SmartMedia cards, Sony's Memory Stick, or any other type of suitable solid-state, or external memory devices may be used to store digital data. The multimedia reproduction apparatus 1 also includes a USB interface 7 which can be used to transmit data from an external computing device, or external memory device, to the multimedia reproduction apparatus 1. A CPU/DSP section 8 controls the operation of the components and also functions as a MPEG decoder. When an external computing device is connected to the USB connector 5d through a USB cable, an analog switch 9 causes the computing device to view the hard disk 6, as an externally connected hard disk. This allows for the seamless transfer of files from the external computing device to hard disk 6. The external computing device could be, for example, a user's personal computer including, for example, software for organizing files and facilitating the transfer of files from the personal computer to the multimedia reproduction apparatus 1 for reproduction.

A flash memory 10 and an SDRAM 11 are also provided which are both connected to the CPU/DSP section 8. The display section 2 described above is connected to the CPU/DSP section 8, and a backlight 12 is provided on a rear face or a side face of the display section 2. A power supply section 13 supplies power to the display section 2, backlight 12 and access lamp 4a. The AV OUT connector 5e is connected to the CPU/DSP section 8 through driver 14 for establishing impedance matching of approximately 75 ohms. The headphone connector 5a is connected to the CPU/DSP section 8 through a digital-to-analog converter 15.

“SUB-CPU” 16 has a battery back-up function, meaning that power is supplied to the “SUB-CPU” 16 when the power supply is off. The “SUB-CPU” 16 performs management functions relating to the battery and also controls the access lamp 4a relating to the battery, management of a resume function as well as other related functions. The resume function allows for the “SUB-CPU” 16, and corresponding memory, to store device settings before the multimedia reproduction apparatus 1 is turned off, then to resume operations with these saved settings when the device is subsequently supplied with power. The “SUB CPU” 16 is also connected to the CPU/DSP section 8 and a key section 17 of operation buttons of the operational panel 3.

A lithium ion battery 18 (or other suitable battery alternative) is connected to the “DC IN” connector 5c through a battery charging section 19. A DC/DC converter 20 converts the DC power supply of the lithium ion battery into DC power of 3.3 volts and 1.5 volts and subsequently supplies power to the components of the multimedia reproduction apparatus 1.

The device is also capable of being controlled by a remote control device. This remote control device, not depicted, can be connected to the multimedia device through the headphone 5a. The remote control device includes a HOLD switch, that when switched to the “HOLD” position prevents mishandling of the remote control buttons when using the unit by locking the functionality of the buttons. The remote also includes “PLAYBACK” and a “STOP” buttons that allow the user to initiate playback and terminate the playing of a selected media file. Fast-forward and fast-reverse buttons are also present on the remote control device that allow for fast-forward or rewind of a file while being played, and also allow for the cursor on the display section 2, to be moved up and down on these respective screens. The remote control device further includes “+” and “−” volume buttons so that the users can control the volume of the music or video file that is being played by the multimedia production apparatus 1.

Below, the relationship between screens which are displayed on the display section 2 and the operation buttons will be described.

If the power supply switch 4b is turned on, then the state of the device, when the power was previously turned off is regenerated based on data stored in the “SUB CPU” 16. This function is referred to as the resuming function.

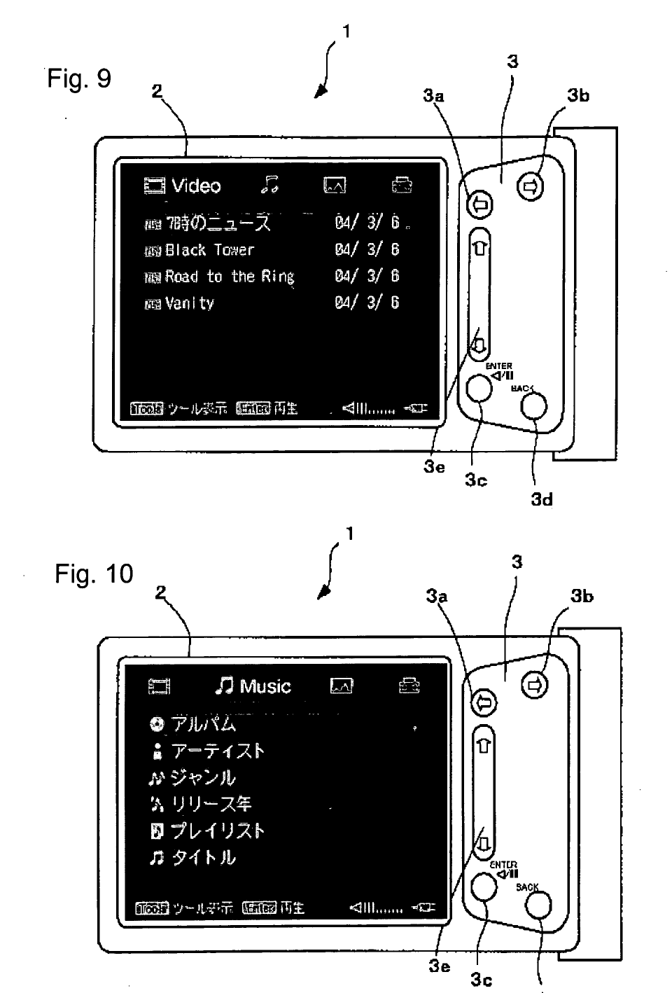

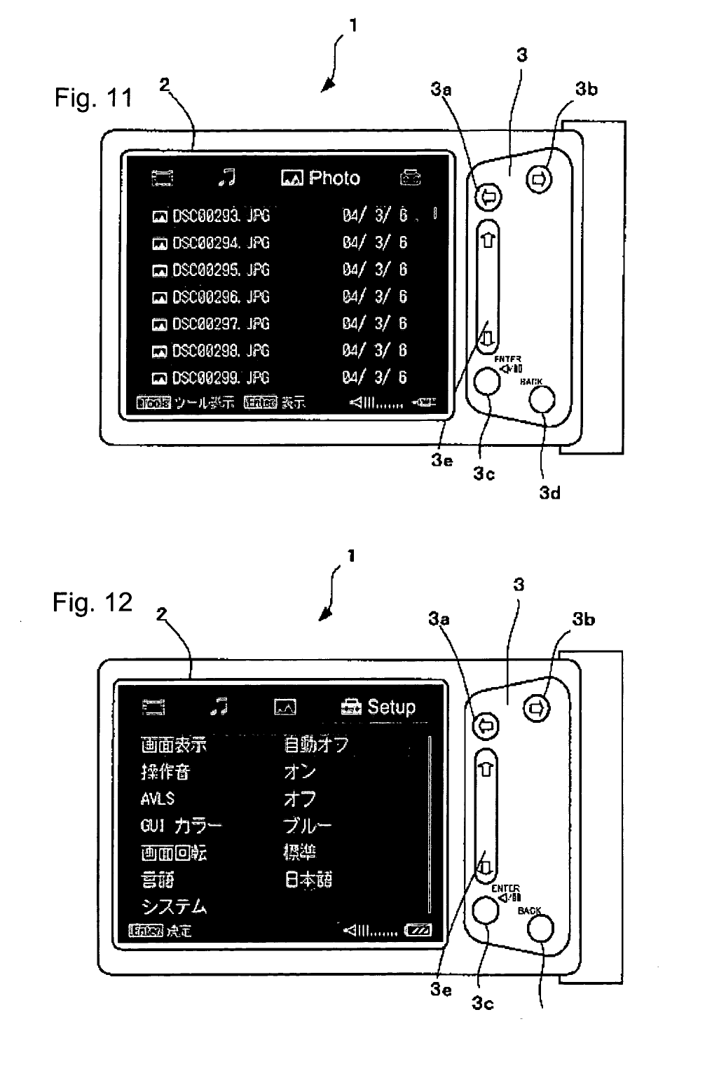

For example, if the last accessed screen in the device is the “Video” menu, then it is subsequently displayed upon resumption of power to the device, as seen in FIG. 9. If the “→” button 3b is touched in this state, the “Music” menu, shown in FIG. 10, is displayed as the next menu in the sequence of menus. If the “→” button 3b is depressed again, then the screen allowing the user to access the “Photo” menu, shown in FIG. 11, is displayed. Further, if the “→” button 3b is depressed once again, then the “Setup” menu, shown in FIG. 12, is displayed. If the “←” button 3a is then depressed, then order of the title screens is accessed in the reverse order. In particular, if the “→” button 3b is depressed successively, then a title list screen successively changes over in order of “Video”, “Music”, “Photo” and “Setup”. However, if the “←” 3a is depressed successively, then the title and corresponding menu of the screen successively changes over in order to “Setup”, “Photo”, “Music” and “Video”. It should be noted that the order in which the above categories are arranged may be altered in a number of ways. Therefore, the operation of the “←” button 3a and “→” button 3b results in the display of title screens in an order different that that depicted above.

Once the user has selected one of the above-mentioned menus, the cursor on the screen of any of the title lists can be moved using the vertical direction button 3e to select a file. The files are displayed as a list vertically, and the format by which they are displayed, as well as the order by which they are displayed are able to be customized by the user, as described above. Under each menu screen the title, date of creation, or other parameters, as customized by the user reflecting the contents of the file can be displayed. If the title of the file is longer than the horizontal space provided on the display section 2, then the title may be scrolled horizontally when the user selects a specified title with the cursor. Alternatively, the device can be set so that all file names, regardless of being selected by the cursor are scrolled. Once the cursor is placed on a specific title, the user can then actuate the ENTER button 3c and the selected file is executed or reproduced.

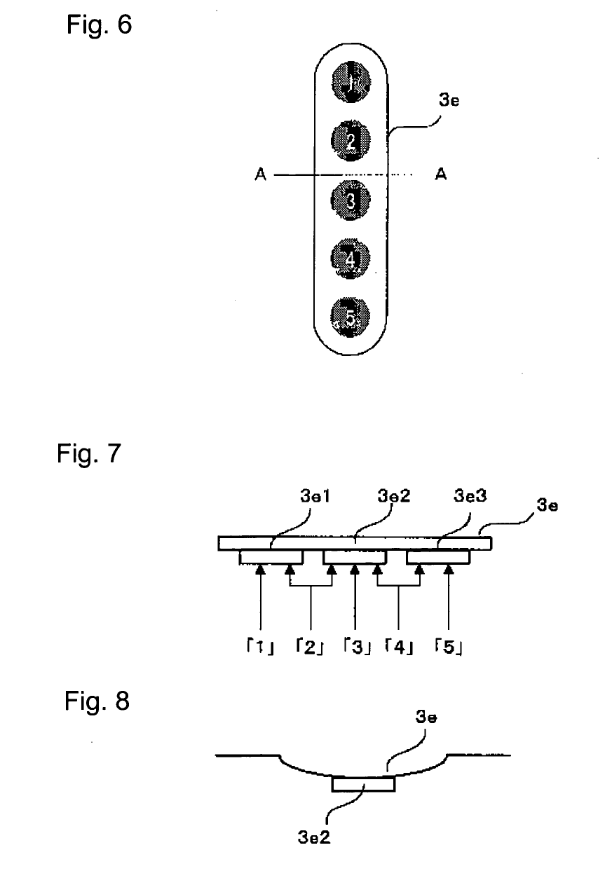

FIG. 6 illustrates a plan view of the “↑/↓” button 3e (vertical direction button). The “↑/↓” button 3e is formed so that 5 virtual sensors, ranging from “1” to “5” are juxtaposed linearly along the vertical direction button. The sensors are referred to as being virtual sensors because the device only includes three touch sensors 3e1 through 3e3 disposed at predetermined intervals on the rear face of the operation panel 3 allowing 5 different sensing locations to be defined. The operation of the vertical direction button will be described in greater detail below. The touch sensors are disposed along a vertical direction of movement of a cursor displayed on the display section 2. The result is an operation that flows intuitively to the user of the device.

As shown in FIG. 7, the “↑/↓” button 3e includes three touch sensors 3e1 through 3e3 disposed at predetermined intervals on the rear face of the operation panel 3. The virtual touch sensors allow for two additional sensor areas to be defined (“2” and “4”), along with virtual touch sensor locations (“1”, “3”, and “5”) at the three physical touch sensor locations 3e1-3e3. Using this configuration, when a user's finger touches a plurality of the sensors at once, then the CPU 8 determines that the user's finger is in the position between two of the sensors. For example, when only touch sensor 3e1 is touched the CPU 8 determines that virtual touch sensor “1” has been touched; when touch sensors 3e1 and 3e2 are touched simultaneously, CPU 8 determines that virtual touch sensor “2” is touched; when only the touch sensor 3e2 is touched, CPU 8 determines that virtual touch sensor “3” is touched; when touch sensors 3e2 and 3e3 are touched simultaneously, CPU 8 determines that virtual touch sensor “4” is touched; and when only the touch sensor 3e3 is touched, CPU 8 determines that virtual touch sensor “5” is touched. As discussed above, this configuration allows three touch sensors to be used in order to operate the sensor to a resolution of up to 5 sensor locations.

FIG. 8 shows a cross section of the sensor along the A-A cross section labeled in FIG. 6. The “↑/↓” button 3e has a concave surface so that erroneous operations from touching one of the sensors inadvertently can be prevented. Each of the “←” button 3a, “→” button 3b, BACK button 3d and ENTER button 3c is formed from a single touch sensor and are also concave in nature.

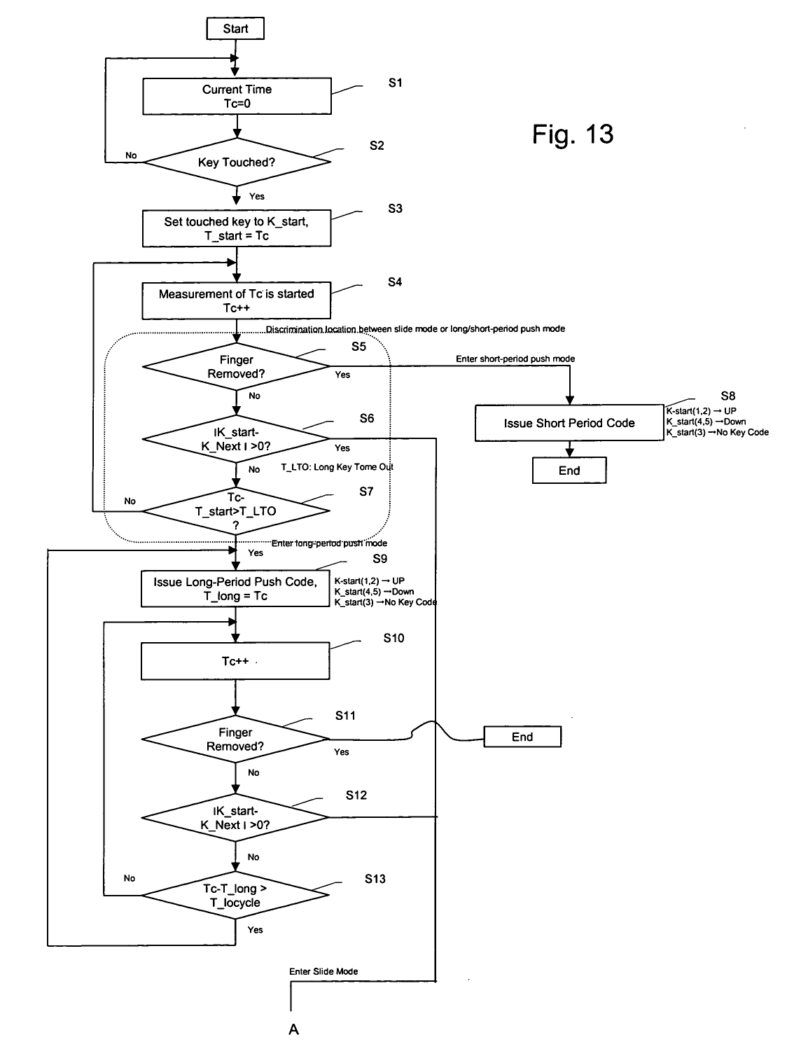

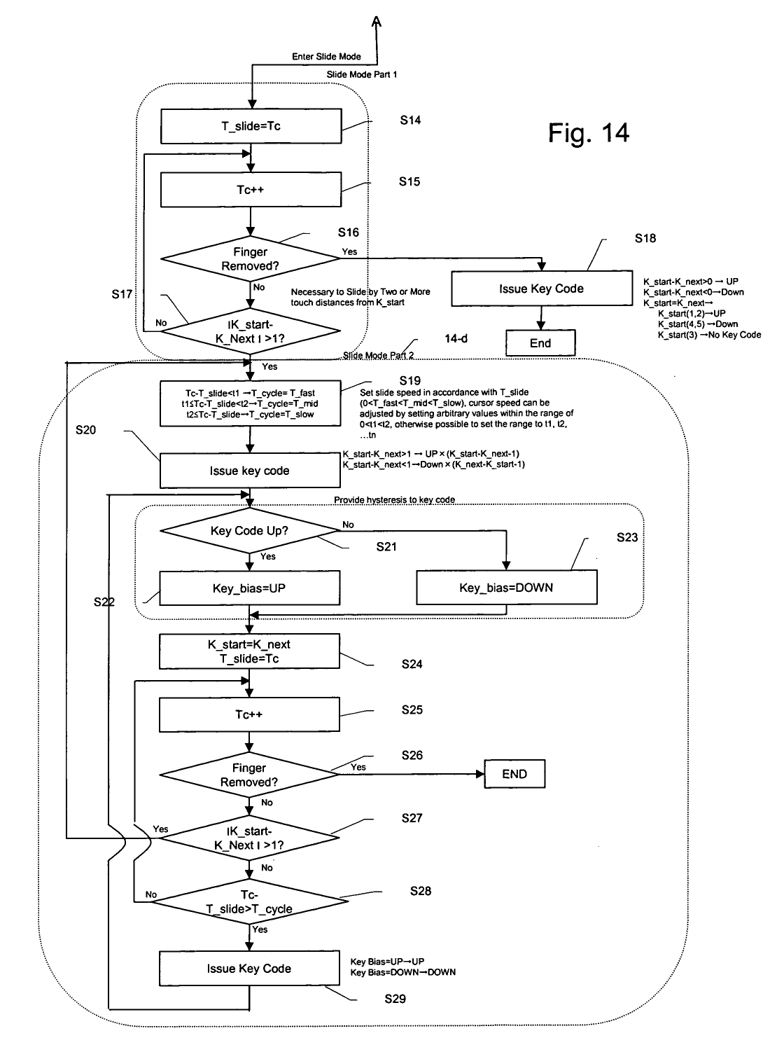

Now the operation of the vertical direction button 3e will be described with reference to the flowcharts depicted in FIGS. 13 and 14. The vertical direction button 3e is capable of moving the cursor on the display section 2 using various modes of functionality. More specifically, the CPU 8 interprets the user's touching of the vertical direction button 3e and moves the sensor accordingly. For example, the cursor on the display section 2 moves up and down in relation to the speed with which the user slides his/her finger. If a finger is slid along the vertical direction button 3e and the motion of the finger stops, but the finger continually remains on the sensor, then the cursor will scroll at a continuous speed relative to the speed with which it was already moving. Once the finger is removed from the vertical direction button 3e, then the cursor stops moving. Further, if the user touches the vertical direction button a single time in the upper or lower potions, the cursor will move one step up or one step down based on the user input.

The operation of the image skipping, and navigating function with respect to the vertical direction button 3e is similar to the operation of the sliding cursor, as described above. However, instead of the issuing of a key code, a skip key code is issued which allows the user to skip though a reproduced file in a manner similar to the method described above, in which the user is navigate the cursor vertically. Accordingly, the discussion below focuses on the steps that result in operations effecting the navigation of the file, and more specifically the issuing of a skip key code in all instances when a key code of any type is issued. Examples of such files being navigated may be a music file, a still image presentation, or a video file.

The vertical direction button 3e is also capable of responding to a user's input in a number of alternative ways, as will be discussed below.

The CPU 8 determines, repetitively, if the vertical direction button buttons 3e is being touched while the current time Tc is reset to Tc=0 (S1, S2).

If, at step S2, the CPU 8 determines that the vertical direction button is being touched, then the touch key is set to K_start and T_start is set to T_start=Tc (S3), and measurement of the time of Tc, in CPU 8 begins (S4). Then, the CPU 8 continuously checks whether the user's finger is removed from the vertical direction button 3e within a predetermined period of time (S5), whether the sensor being touched changes by a sliding movement (S6) and whether the period of time within which the finger touches is within a predetermined period of time (S7).

At step S5, if the CPU 8 determines that the user's finger is removed from the vertical direction button 3e within a predetermined period of time, then a short-period push key mode is entered and a short-period push code is issued (S8). The short-period push code results in a movement of the cursor. If K_start is “1” or “2” (virtual touch sensor “1” or “2” is touched), then a code for moving the cursor up is issued. If K_start is “4” or “5” (virtual touch sensor “4” or “5” is touched), a code for moving the cursor down is issued. If K_start is “3” (virtual touch sensor “3” is touched) then no code is issued and the cursor remains stationary. If the user is in a mode of viewing a reproduced image then, based on the issuing of this short-period push-code, the image skips for a predetermined period of time, for example, approximately 15 seconds.

If the virtual touch sensor being touched does not change because the user's finger does not perform a sliding motion (S6) and the period of time within the vertical direction button 3e is touched exceeds a predetermined period of time (S7), then a long-period push key mode is entered and a long-period push code is issued (S9). T_long is set to T_long=Tc.

If long-period push key mode is entered and K_start is “1” or “2” (virtual touch sensor “1” or “2” is touched), then a code for moving the cursor up is issued. If K_start is “4” or “5” (virtual touch sensor “4” or “5” is touched), then a code for moving the cursor down is issued. If K_start is “3” (virtual touch sensor “3” is touched), then no new code for moving the cursor is issued.

Measurement of the period of time of Tc is started (S10), and the CPU 8 repetitively checks whether or not the user's fingers are removed vertical direction button 3e within a predetermined period of time (S11), whether the virtual sensor being touched changes by sliding movement (S12) and whether the period of time that the user's finger touches the sensor is within a predetermined period of time (S13).

If the user's finger is removed from the vertical direction button 3e within a predetermined period of time, then the processing is ended. If the sensor being touched does not change because there is no detection of a sliding motion of the user's finger and the period of time that the vertical direction button 3e is touched exceeds the predetermined period of time, then the long-period push key mode is entered again and the long-period push key code is issued (S9). This allows the user to step through the vertically listed file selections by holding the vertical direction button 3e continuously. If the user is in the mode of viewing a reproduced file then the reproduced file skips for a predetermined period of time, for example approximately 30 seconds, 45 seconds, or longer in response to the period of time corresponding to the period of time with which the user's finger touches the sensor.

At step S6 or S12, if it detected that the sensor being touched changes as a result of sliding movement of a user's finger, then a slide mode is entered. FIG. 14 illustrates a flow chart detailing the steps performed in relation to a sliding motion.

At step (S 14), T_slide is set to T_slide=Tc (S14), and measurement of the time of Tc begins (S15). The CPU 8 repetitively checks whether or not the user's finger is removed from the vertical direction button 3e (S16) and whether or not the virtual touch sensors spaced by two or more touch sensor distances (i.e. from virtual sensor “1” to virtual sensor “3”) from the touch sensor of K_start are touched as a result of sliding movement of the user's finger (S17).

If a virtual touch sensor two or more virtual touch sensor distances from the touch sensor of K_start is not touched as a result of sliding movement, that is if the sliding movement of the user's finger is performed by the user's finger moving one or fewer virtual touch sensor distance (i.e. “1” to “2”, or “1” to “1”), then the corresponding key codes, as described below, are issued (S18). If the sliding movement is performed in an upward direction, then a code is issued causing the cursor to move upwards. If the sliding movement is performed in a downward direction, then a code is issued for moving the cursor downward. If no sliding movement is performed, then a key code is issued similarly to the short-period push mode codes as described in relation to step S8. In particular, if K_start is “1” or “2” (virtual touch sensor “1” or “2” is touched), then a code for moving the cursor up is issued. If K_start is “4” or “5” (virtual touch sensor “4” or “5” is touched), a code for moving the cursor down is issued. If K_start is “3” (virtual touch sensor “3” is touched), no code is issued and the cursor remains stationary.

If the motion of the user's finger results in the touch sensor spaced by two or more virtual touch sensors distances from K_start being touched, then speed of movement of the cursor is set in accordance with the speed of the sliding movement (S19) and a key code is issued accordingly (S20). When 0<t1<t2, if Tc−T_slide <t1, then the speed of the sliding movement is a high speed; if t1≦Tc−T_slide<t2, then the speed of the sliding speed is a medium speed; and if t2≦Tc−T_slide, then the sliding speed is a low speed. In this instance t1, t2 . . . tn are arbitrarily set values which dictate the speed that the user's finger must slide to fit into each respective speed setting, and if tn is set suitably, finer speed settings are possible.

When the direction of the detected sliding movement is upwards, a code for moving the cursor upward at the corresponding set speed is issued. When the direction of the sliding movement is downward, another code for moving the cursor downwards at a set speed is issued.

After a key code is issued at S20, a bias is provided to the key code. In particular, the CPU 8 detects whether the key code is increased or decreased thereafter (S21). If the key code is up, then Key_bias is set to Key_bias=UP (S22), and if the key code is down, then Key_bias is set to Key_bias=DOWN (S23).

At step S24 all measurement times are reset to the current time and measurement of the time of Tc begins (S25). Then, the CPU 8 repetitively checks whether the user's fingers are removed from the vertical direction button 3e (S26), whether a touch sensor spaced by two or more touch sensor distances from the touch sensor of K_start is touched as a result of a sliding movement of the user's fingers and the time interval T_cycle after which the key code set at S19 is issued.

If at S26 the CPU 8 detects that the user's fingers are removed from the vertical direction button 3e, processing is ended. If a touch sensor spaced by two or more touch sensor distances from the touch sensor of K_start is touched as a result of the sliding movement, the processing returns to S19 where a corresponding key code is again issued (S27).

If a touch sensor spaced by two or more touch sensor distances from the touch sensor of K_start is not touched as a result of the detection of a sliding motion of the user's finger and the period of time is longer than T_cycle set at S19 elapses after S24 (S28), then a key code for a direction corresponding to Key_bias set at S22, S23 is issued (S29).

In this manner, when a virtual touch sensor spaced by two or more virtual touch sensor distances from the touch sensor is touched, the CPU 8 determines that the touch is not sliding movement. Therefore, when the user does not intend to perform a sliding movement but intends to only perform a single touch and the user's finger moves slightly, an inadvertent operation is not performed.

By using the above described operations in relation to the vertical direction button 3e a user can easily navigate through a list of presented files or through a file being reproduced by the multimedia reproduction apparatus 1 with ease.

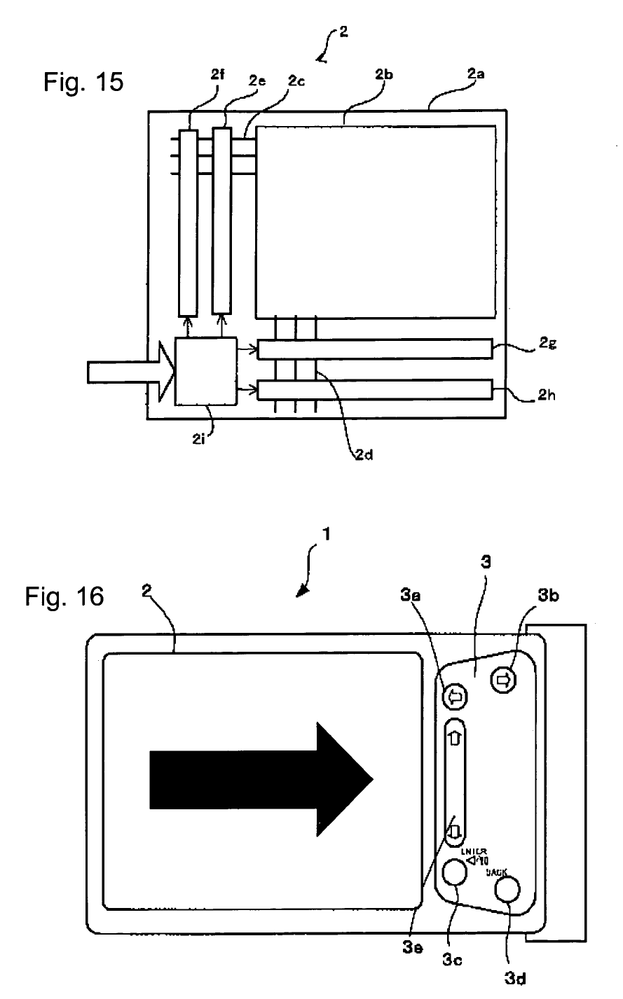

FIG. 15 is a view showing an example of the configuration of the display section 2 as previously described.

Referring to FIG. 15, a first glass substrate 2a and a second glass substrate 2b are provided in the display section 2 of the multimedia reproduction apparatus 1. Liquid crystal is interposed between the glass substrates 2a and 2b. A large number of scanning wire lines 2c extend horizontally from the liquid crystal section on the side of a projecting portion of the first glass substrate 2a and a large number of data wiring lines 2d extend vertically across the liquid crystal interposing section from the side of the projecting portion of the first glass substrate 2a.

A scanning driver 2e as well as a scanning driver 2f used for vertical inversion are connected to the scanning wiring lines 2c. Accordingly, a data driver 2g and a data driver for vertical inversion 2h are connected to the data wiring lines 2d. As an alternative, drivers which are inverted vertically relative to each other may be used for the scanning driver 2e and the vertical inversion scanning driver 2f. Further, drivers which are connected horizontally relative to each other may be used for the data driver 2g and the vertical inversion data driver 2h. The inversion of the image displayed on the display section 2 will be described in greater detail below.

A display control section 2i performs a process for displaying image data, as well as other information input from the CPU 8 using the liquid crystal and outputting predetermined signals to the ordinary scanning driver 2e or the vertical inversion scanning driver 2f and the ordinary data driver 2g or the data driver for vertical inversion 2h. The display control section 2i outputs signals to the scanning driver 2e and the data driver 2g when normal display operations are performed. However, if a vertical inversion signal is input from the CPU/DSP section 8, then the display control section 2i outputs signals to the scanning driver 2f for vertical inversion in the vertical inversion data driver 2h.

As discussed briefly above, the multimedia reproduction apparatus 1 is configured to be easily operated by a user's single hand whether they are right-handed or left-handed. To facilitate user friendly operations for a left-handed user the multimedia reproduction apparatus 1 includes an inversion function that allows for the displayed image, as well as the operation of the user interface (touch sensors), to be inverted.

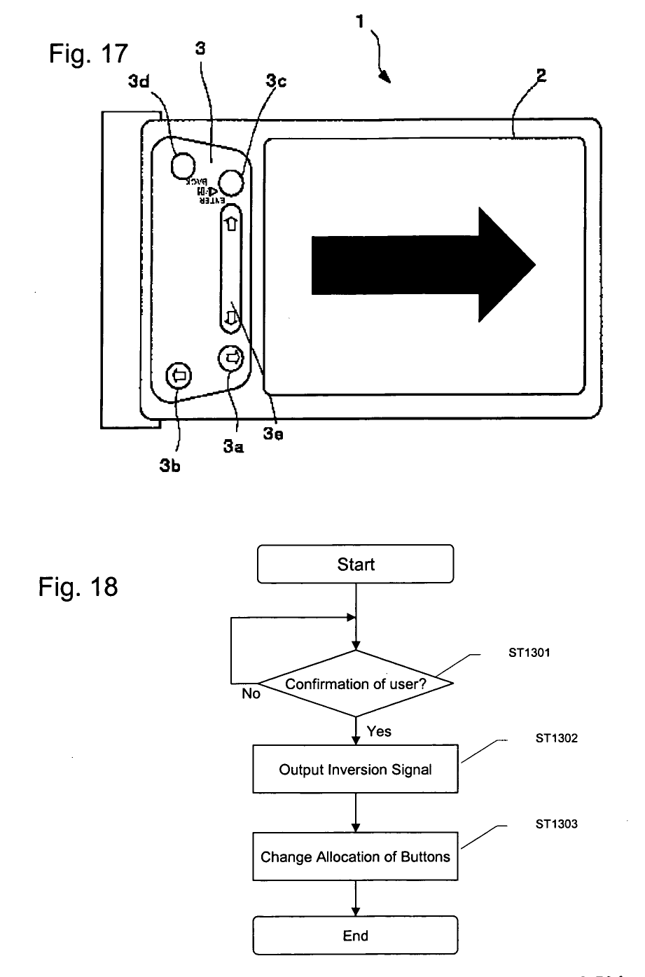

One of the options in the “Setup” menu is the “screen rotation” option, changeover can be performed between an ordinary screen shown in FIG. 16 and a vertically inverted screen (screen rotated by 180°) shown in FIG. 17. The vertically inverted screen can be used by a left-handed user, or can also be used by a right-handed person who has held the multimedia reproduction apparatus 1 until she/he is tired and has the need to use the device in an inverted manner.

Now the vertical inverting operation will be described with reference to the flowchart depicted in FIG. 18.

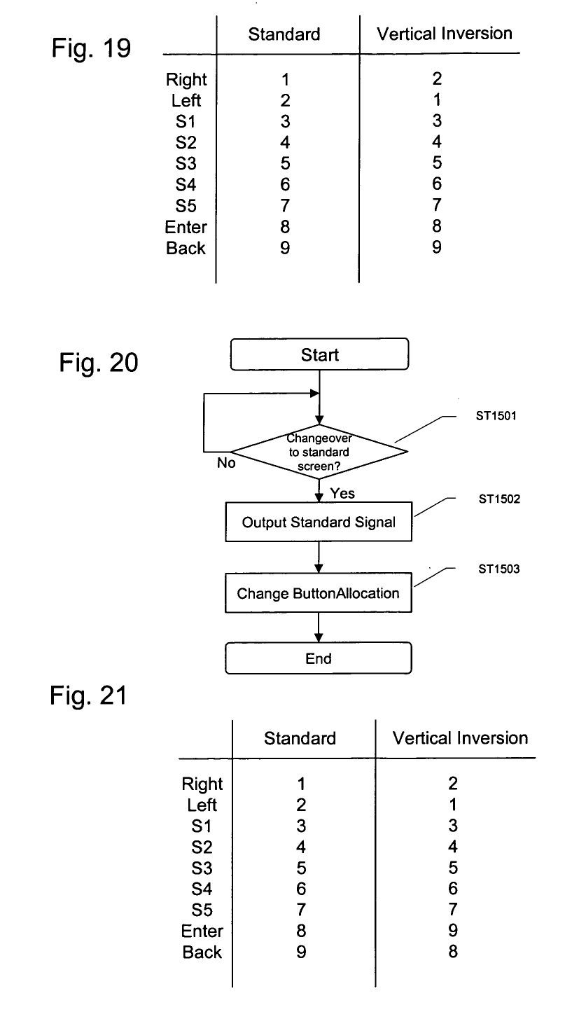

If the user requests changeover to the vertically inverted screen by selecting the “screen rotation” option as described above (step 1301), then a vertical inversion signal is output from the CPU 8 (step 1302). This vertical inversion signal is input to the display control section 2i of the display section 2, and a vertically inverted screen, for example, a vertically inverted image, is displayed on the display section 2. Simultaneously, a table shown in FIG. 19 (stored, for example, in the flash memory 10) is accessed and the allocation button functionality is changed from “standard” to “vertical inversion” (step 1303).

For example, the function of the “←” button 3a and the “→” button 3b is reversed. More particularly, in the standard configuration, if the “→” button 3b is depressed successively, then the title list screen successively changes over in order of “Video”, “Music”, “Photo” and “Setup”, but if the “←” 3a is depressed successively, then the title list screen successfully changes over in order to “Setup”, “Photo”, “Music”, and “Video”. However, in the vertically inverted allocation, if the “←” button 3a is depressed successively, then the title list screen successively changes over in order to “Video”, “Music”, “Photo” and “Setup”, but if the “→” button 3b is depressed successively, then the title list screen successfully changes over in order to “Setup”, “Photo”, “Music” and “Video”.

Further, in this configuration, image data output from the AV OUT connector 5e is not in inverted form, since the inversion takes place at the display control section 2i. Thus, an ordinary image signal output from the AV OUT connector 5e that may be displayed on a television or other display apparatus is not vertically inverted, while the image displayed on the display section 2 is inverted.

Further, in the standard configuration, if the “→” button 3b is depressed during reproduction of an image file, a fast-forwarding function is performed, but if the “←” button 3a is depressed, a rewind operation is then performed. However, in the vertically inverted configuration, if the “←” button 3a is depressed during reproduction of an image file, then a fast-forward function is performed, but if the “→” button 3b is depressed, then a rewind operation is performed.

Alternatively, if the configuration is changed from vertical inversion to standard operation (step 1501), a standard signal is outputted from the CPU/DSP section 8 (step 1502). This standard signal is input to the display control section 2i of the display section 2, and a standard screen, for example, a standard image, is displayed on the display section 2. Simultaneously, the table illustrated in FIG. 19 (stored, for example, in the flash memory 10) is accessed, and the button configuration is changed from “vertical inversion” to “standard” (step 1503).

As described in FIGS. 21-23 the inversion function can cause the buttons to operate in a plurality of different configurations. These configurations are presented as examples, and various other button configurations are also possible.

In the embodiment described above, if vertical inversion is performed, then the allocation of functions to the “←” button 3a and the “→” button 3b is reversed. Naturally, however it is possible to reverse the allocation of functions to the ENTER button 3c and the BACK button 3d. In this instance, preferably the ENTER button 3c and the BACK button 3d have indication marks which are leftwardly and rightwardly symmetrically relative to each other. A table corresponding to FIG. 19 in this instance is shown in FIG. 21.

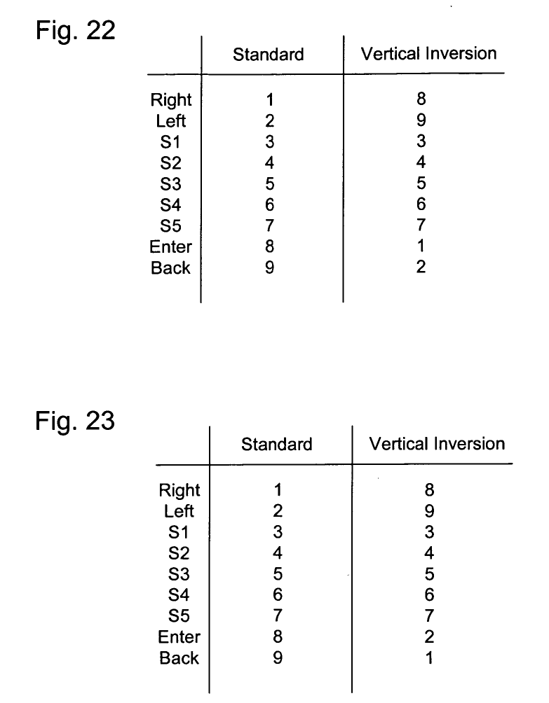

The table depicted in FIG. 22 also depicts an alternative button configuration when the multimedia reproduction apparatus 1 is in inversion mode. As shown in FIG. 22, elements for reversing the functional allocation to the “←” button 3a and the “→” button 3b can be brought to the positions at which the ENTER button 3c and the BACK button 3d are positioned. In other words, where the “←” button 3a and the “→” button 3b are positioned on the lower side in the standard allocation, these buttons can be located in the same space in the vertically inverted configuration. Further, where the table shown in FIG. 23 is provided, also the ENTER button 3c and the BACK button 3d can be reversed.

It should be noted that the version of firmware incorporating such a table as described above may be incorporated from a personal computer when the personal computer is connected to the USB connector 5d through a USB cable. In this instance, the data for the version is stored on the hard disk 6, and the mode of operation is confirmed by the user. Where such a verification mode is provided and the data of the mode is not received from a personal computer but from an apparatus which does not include a display mechanism, the user is able to visually verify the altered mode.

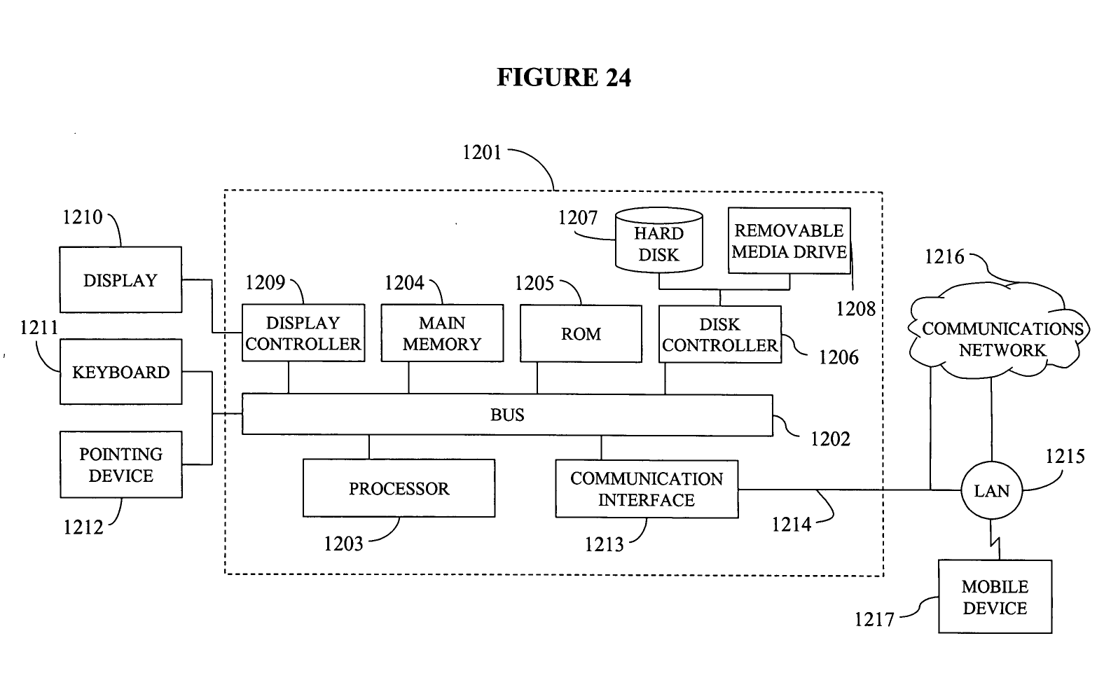

FIG. 24 illustrates a computer system 1201 from which files can be stored and transferred to an embodiment of the present invention. The computer system 1201 includes a bus 1202 or other communication mechanism for communicating information, and a processor 1203 coupled with the bus 1202 for processing the information. The computer system 1201 also includes a main memory 1204, such as a random access memory (RAM) or other dynamic storage device (e.g., dynamic RAM (DRAM), static RAM (SRAM), and synchronous DRAM (SDRAM)), coupled to the bus 1202 for storing information and instructions to be executed by processor 1203. In addition, the main memory 1204 may be used for storing temporary variables or other intermediate information during the execution of instructions by the processor 1203. The computer system 1201 further includes a read only memory (ROM) 1205 or other static storage device (e.g., programmable ROM (PROM), erasable PROM (EPROM), and electrically erasable PROM (EEPROM)) coupled to the bus 1202 for storing static information and instructions for the processor 1203.

The computer system 1201 also includes a disk controller 1206 coupled to the bus 1202 to control one or more storage devices for storing information and instructions, such as a magnetic hard disk 1207, and a removable media drive 1208 (e.g., floppy disk drive, read-only compact disc drive, read/write compact disc drive, compact disc jukebox, tape drive, and removable magneto-optical drive). The storage devices may be added to the computer system 1201 using an appropriate device interface (e.g., small computer system interface (SCSI), integrated device electronics (IDE), enhanced-IDE (E-IDE), direct memory access (DMA), or ultra-DMA).

The computer system 1201 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 1201 may also include a display controller 1209 coupled to the bus 1202 to control a display 1210, such as a cathode ray tube (CRT), for displaying information to a computer user. The computer system includes input devices, such as a keyboard 1211 and a pointing device 1212, for interacting with a computer user and providing information to the processor 1203. The pointing device 1212, for example, may be a mouse, a trackball, or a pointing stick for communicating direction information and command selections to the processor 1203 and for controlling cursor movement on the display 1210. In addition, a printer may provide printed listings of data stored and/or generated by the computer system 1201.

The computer system 1201 performs a portion or all of the processing steps of the invention in response to the processor 1203 executing one or more sequences of one or more instructions contained in a memory, such as the main memory 1204. Such instructions may be read into the main memory 1204 from another computer readable medium, such as a hard disk 1207 or a removable media drive 1208. One or more processors in a multi-processing arrangement may also be employed to execute the sequences of instructions contained in main memory 1204. In alternative embodiments, hard-wired circuitry may be used in place of or in combination with software instructions. Thus, embodiments are not limited to any specific combination of hardware circuitry and software.

As stated above, the computer system 1201 includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system 1201, for driving a device or devices for implementing the invention, and for enabling the computer system 1201 to interact with a human user (e.g., print production personnel). Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

The term “computer readable medium” as used herein refers to any medium that participates in providing instructions to the processor 1203 for execution. A computer readable medium may take many forms, including but not limited to, non-volatile media, volatile media, and transmission media. Non-volatile media includes, for example, optical, magnetic disks, and magneto-optical disks, such as the hard disk 1207 or the removable media drive 1208. Volatile media includes dynamic memory, such as the main memory 1204. Transmission media includes coaxial cables, copper wire and fiber optics, including the wires that make up the bus 1202. Transmission media also may also take the form of acoustic or light waves, such as those generated during radio wave and infrared data communications.

Various forms of computer readable media may be involved in carrying out one or more sequences of one or more instructions to processor 1203 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to the computer system 1201 may receive the data on the telephone line and use an infrared transmitter to convert the data to an infrared signal. An infrared detector coupled to the bus 1202 can receive the data carried in the infrared signal and place the data on the bus 1202. The bus 1202 carries the data to the main memory 1204, from which the processor 1203 retrieves and executes the instructions. The instructions received by the main memory 1204 may optionally be stored on storage device 1207 or 1208 either before or after execution by processor 1203.

The computer system 1201 also includes a communication interface 1213 coupled to the bus 1202. The communication interface 1213 provides a two-way data communication coupling to a network link 1214 or a USB interface that is connected to, for example, a local area network (LAN) 1215, or to another communications network 1216 such as the Internet, or to the multimedia device 1. For example, the communication interface 1213 may be a network interface card to attach to any packet switched LAN. As another example, the communication interface 1213 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 1213 sends and receives electrical, electromagnetic or optical signals that carry digital data streams representing various types of information.

The network link 1214 typically provides data communication through one or more networks to other data devices. For example, the network link 1214 may provide a connection to another computer through a local network 1215 (e.g., a LAN) or through equipment operated by a service provider, which provides communication services through a communications network 1216. The local network 1214 and the communications network 1216 use, for example, electrical, electromagnetic, or optical signals that carry digital data streams, and the associated physical layer (e.g., CAT 5 cable, coaxial cable, optical fiber, etc). The signals through the various networks and the signals on the network link 1214 and through the communication interface 1213, which carry the digital data to and from the computer system 1201 maybe implemented in baseband signals, or carrier wave based signals. The baseband signals convey the digital data as unmodulated electrical pulses that are descriptive of a stream of digital data bits, where the term “bits” is to be construed broadly to mean symbol, where each symbol conveys at least one or more information bits. The digital data may also be used to modulate a carrier wave, such as with amplitude, phase and/or frequency shift keyed signals that are propagated over a conductive media, or transmitted as electromagnetic waves through a propagation medium. Thus, the digital data may be sent as unmodulated baseband data through a “wired” communication channel and/or sent within a predetermined frequency band, different than baseband, by modulating a carrier wave. The computer system 1201 can transmit and receive data, including program code, through the network(s) 1215 and 1216, the network link 1214 and the communication interface 1213. Moreover, the network link 1214 may provide a connection through a LAN 1215 to a mobile device 1217 such as a personal digital assistant (PDA) laptop computer, or cellular telephone.

Obviously, numerous modifications and variations of the present invention are possible in light of the above teachings. It is therefore to be understood that within the scope of the appended claims, the invention may be practiced otherwise than as specifically described herein.

The present application also claims priority to Japanese Patent Application No. 2004-188203, filed Jun. 25, 2004, and Japanese Patent Application No. 2004-188611, filed Jun. 25, 2004, each of which are entirely incorporated herein by reference.

What is claimed:

1. A hand-held display apparatus, comprising:
a body configured to be gripped by a user's hand;
an interface configured to output image data;
a display configured to display an image received from the interface and vertically invert the image in response to a vertical inversion signal;
a plurality of sensors disposed in proximity to the display symmetrically around a horizontal axis in relation to the display section, the sensors configured to be manipulated by a user's hand; and
a processor configured to output the vertical inversion signal and reverse the functionality of at least one of the plurality of sensors.

2. The method of claim 1, wherein:
the processor is configured to invert the operation of the sensors around the horizontal axis in response to a vertical inversion signal.

3. The apparatus of claim 1, wherein:
a pair of the plurality of the sensors include indication marks provided thereon which are leftwardly and rightwardly symmetrical to each other.

4. The apparatus of claim 3, wherein:
the processor transfers the function of the a pair of the plurality of the sensors including indication marks provided thereon which are leftwardly and rightwardly symmetrical to another pair of sensors in response to the vertical inversion signal.

5. The apparatus of claim 1, wherein:
the processor is configured to configured to perform fast-forward and rewind functions based on a user input to a pair of the plurality of sensors.

6. The apparatus of claim 5, wherein:
the processor reverses the function corresponding to the pair of sensors in response to the vertical inversion signal.

7. The apparatus of claim 1, wherein:
the processor is configured to display a plurality of menu screens on the display in a predetermined order

8. The apparatus of claim 7, wherein:
the processor reverses the order in which the screens are displayed in response to the vertical inversion signal.

9. A hand-held display apparatus, comprising:
outputting image data by an interface configured to output image data;
displaying an image received from the interface;
inputting commands, by a user's hand, to a plurality of sensors disposed in proximity to the display section symmetrically around a horizontal axis in relation to the display section; and
outputting the vertical inversion signal;
vertically inverting the image in response to a vertical inversion signal;
reversing the functionality of at least one of the plurality of sensors based on the vertical inversion signal.

10. The method of claim 1, wherein the step of reversing the functionality of at least one of the plurality of sensors comprises:
inverting the operation of the sensors around the horizontal axis in response to the vertical inversion signal.

11. The method of claim 1, wherein the step of inputting commands comprises:
inputting commands to a pair of the plurality of the sensors which include indication marks provided thereon which are leftwardly and rightwardly symmetrical to each other.

12. The apparatus of claim 11, further comprising:
transferring the functionality of the a pair of the plurality of the sensors including indication marks provided thereon to another pair of sensors in response to the vertical inversion signal.

13. The apparatus of claim 1, wherein the step of inputting commands comprises:
inputting commands to a pair of the plurality of sensors which cause a processor to perform fast-forward and rewind functions based on a user input.

14. The apparatus of claim 13, wherein:
the functions corresponding to each of the pair of sensors is respectively reversed in response to the vertical inversion signal.

15. The apparatus of claim 1, further comprising:
display a plurality of menu screens in a predetermined order

16. The apparatus of claim 15, further comprising:
reversing the order in which the screens are displayed in response to the vertical inversion signal.
